(19) United States
(12) Patent Application Publication
(10) Pub. No.: US 2020/0111067 A1
(43) Pub. Date: Apr. 9, 2020

(54) LEDGER PROCESSING SYSTEM AND METHOD

(71) Applicant: Holland & Knight LLP, Brandon, FL (US)

(72) Inventors: JOSHUA A. STRICKON, Key Biscayne, FL (US); Josias N. Dewey, Parkland, FL (US)

(21) Appl. No.: 16/595,256

(22) Filed: Oct. 7, 2019

Related U.S. Application Data
(60) Provisional application No. 62/741,680, filed on Oct. 5, 2018.

(51) Int. Cl. G06Q 20/06; H04L 9/06; G06Q 20/36; G06Q 20/40; G06Q 20/38; G06F 16/182

(52) U.S. Cl. CPC G06Q 20/0658; H04L 9/0637; G06F 16/1837; G06Q 20/4016; G06Q 20/3829; G06Q 20/3674

(57) ABSTRACT

A computer-implemented method, computer program product and computing system for obtaining distributed ledgering data that defines a plurality of transactions; processing the distributed ledgering data to identify a plurality of unique identifiers within the distributed ledgering data; and associating two or more unique identifiers included within the plurality of unique identifiers with discrete transactions included within the plurality of transactions to generate transfer data.

### RELATED APPLICATION(S)

This application claims the benefit of U.S. Provisional Application No. 62/741,680, filed on 5 Oct. 2018, the entire contents of which are incorporated herein by reference.

### TECHNICAL FIELD

This disclosure relates to distributed ledgering systems and, more particularly, to systems and methods for extracting data from distributed ledgering systems.

### BACKGROUND

Cryptocurrency systems often utilize distributed ledgering systems to monitor and memorialize the transactions that were effectuate using such cryptocurrencies. These distributed ledgering system often use cryptography to reduce the likely of tampering with the data included in such distributed ledgering systems.

Unfortunately, as the use of such cryptocurrency systems continues to grow, the quantity of data included within such distributed ledgering systems is skyrocketing, making it more difficult for the users of such cryptocurrency systems to research transactions and/or currency flows with such cryptocurrency systems.

### SUMMARY OF DISCLOSURE

In one implementation, a computer-implemented method is executed on a computing system and includes: obtaining distributed ledgering data that defines a plurality of transactions; processing the distributed ledgering data to identify a plurality of unique identifiers within the distributed ledgering data; and associating two or more unique identifiers included within the plurality of unique identifiers with discrete transactions included within the plurality of transactions to generate transfer data.

One or more of the following features may be included. The distributed ledgering data may concern at least one cryptocurrency. The plurality of transactions may concern a plurality of transfers of the at least one cryptocurrency. The plurality of unique identifiers may include a plurality of unique public encryption keys. Processing the distributed ledgering data to identify a plurality of unique identifiers within the distributed ledgering data may include deconstructing the distributed ledgering data to populate a distributed ledgering database. Supplemental ledgering data that defines a plurality of supplemental transactions may be obtained. The supplemental ledgering data may be processed to identify a plurality of supplemental identifiers within the supplemental ledgering data. Processing the supplemental ledgering data to identify a plurality of supplemental identifiers within the supplemental ledgering data may include deconstructing the supplemental ledgering data to update a distributed ledgering database.

A query may be received concerning a user-defined identifier. Whether the user-defined identifier is included within the plurality of unique identifiers may be determined. If included within the plurality of unique identifiers, one or more objects related to the user-defined identifier may be identified. The user-defined identifier may concern a user-defined entity. Identifying one or more objects related to the user-defined identifier may include identifying one or more entities related to the user-defined identifier, thus defining one or more related entities. Identifying one or more objects related to the user-defined identifier may include identifying one or more transactions related to user-defined specific identifier, thus identifying one or more related transactions. Obtaining distributed ledgering data that defines a plurality of transactions may include obtaining distributed ledgering data that defines a plurality of transactions from a plurality of distributed ledgers. The distributed ledgering data may concern a plurality of cryptocurrencies. Distributed ledgering data concerning a first cryptocurrency may be monitored. Distributed ledgering data concerning at least a second cryptocurrency may be monitored. One or more transactions concerning the first cryptocurrency may be associated with one or more transactions concerning the at least a second cryptocurrency, thus enabling the mapping of potential relationships across multiple blockchain networks. The plurality of unique identifiers may be compared to a list of known bad actors to identify one or more suspect transactions within the plurality of transactions. The transfer data may be compared to a list of known suspect transfer patterns to identify one or more suspect transactions within the plurality of transactions. The transfer data may include temporal transfer data. Comparing the transfer data to a list of known suspect transfer patterns to identify one or more suspect transactions within the plurality of transactions may include comparing the temporal transfer data to a list of known suspect temporal transfer patterns to identify one or more suspect transactions within the plurality of transactions. The distributed ledgering data may be supplemented with third-party content that associates at least a portion of the plurality of unique identifiers with one or more known entities. Associating two or more unique identifiers included within the plurality of unique identifiers with discrete transactions included within the plurality of transactions to generate transfer data may include associating two or more unique identifiers included within the plurality of unique identifiers and any associated known entities with discrete transactions included within the plurality of transactions to generate transfer data.

In another implementation, a computer program product resides on a computer readable medium and has a plurality of instructions stored on it. When executed by a processor, the instructions cause the processor to perform operations including: obtaining distributed ledgering data that defines a plurality of transactions; processing the distributed ledgering data to identify a plurality of unique identifiers within the distributed ledgering data; and associating two or more unique identifiers included within the plurality of unique identifiers with discrete transactions included within the plurality of transactions to generate transfer data.

One or more of the following features may be included. The distributed ledgering data may concern at least one cryptocurrency. The plurality of transactions may concern a plurality of transfers of the at least one cryptocurrency. The plurality of unique identifiers may include a plurality of unique public encryption keys. Processing the distributed ledgering data to identify a plurality of unique identifiers within the distributed ledgering data may include deconstructing the distributed ledgering data to populate a distributed ledgering database. Supplemental ledgering data that defines a plurality of supplemental transactions may be obtained. The supplemental ledgering data may be processed to identify a plurality of supplemental identifiers within the supplemental ledgering data. Processing the supplemental ledgering data to identify a plurality of supplemental identifiers within the supplemental ledgering data may include deconstructing the supplemental ledgering data to update a distributed ledgering database.

A query may be received concerning a user-defined identifier. Whether the user-defined identifier is included within the plurality of unique identifiers may be determined. If included within the plurality of unique identifiers, one or more objects related to the user-defined identifier may be identified. The user-defined identifier may concern a user-defined entity. Identifying one or more objects related to the user-defined identifier may include identifying one or more entities related to the user-defined identifier, thus defining one or more related entities. Identifying one or more objects related to the user-defined identifier may include identifying one or more transactions related to user-defined specific identifier, thus identifying one or more related transactions. Obtaining distributed ledgering data that defines a plurality of transactions may include obtaining distributed ledgering data that defines a plurality of transactions from a plurality of distributed ledgers. The distributed ledgering data may concern a plurality of cryptocurrencies. Distributed ledgering data concerning a first cryptocurrency may be monitored. Distributed ledgering data concerning at least a second cryptocurrency may be monitored. One or more transactions concerning the first cryptocurrency may be associated with one or more transactions concerning the at least a second cryptocurrency, thus enabling the mapping of potential relationships across multiple blockchain networks. The plurality of unique identifiers may be compared to a list of known bad actors to identify one or more suspect transactions within the plurality of transactions. The transfer data may be compared to a list of known suspect transfer patterns to identify one or more suspect transactions within the plurality of transactions. The transfer data may include temporal transfer data. Comparing the transfer data to a list of known suspect transfer patterns to identify one or more suspect transactions within the plurality of transactions may include comparing the temporal transfer data to a list of known suspect temporal transfer patterns to identify one or more suspect transactions within the plurality of transactions. The distributed ledgering data may be supplemented with third-party content that associates at least a portion of the plurality of unique identifiers with one or more known entities. Associating two or more unique identifiers included within the plurality of unique identifiers with discrete transactions included within the plurality of transactions to generate transfer data may include associating two or more unique identifiers included within the plurality of unique identifiers and any associated known entities with discrete transactions included within the plurality of transactions to generate transfer data.

In another implementation, a computing system includes a processor and memory is configured to perform operations including obtaining distributed ledgering data that defines a plurality of transactions; processing the distributed ledgering data to identify a plurality of unique identifiers within the distributed ledgering data; and associating two or more unique identifiers included within the plurality of unique identifiers with discrete transactions included within the plurality of transactions to generate transfer data.

One or more of the following features may be included. The distributed ledgering data may concern at least one cryptocurrency. The plurality of transactions may concern a plurality of transfers of the at least one cryptocurrency. The plurality of unique identifiers may include a plurality of unique public encryption keys. Processing the distributed ledgering data to identify a plurality of unique identifiers within the distributed ledgering data may include deconstructing the distributed ledgering data to populate a distributed ledgering database. Supplemental ledgering data that defines a plurality of supplemental transactions may be obtained. The supplemental ledgering data may be processed to identify a plurality of supplemental identifiers within the supplemental ledgering data. Processing the supplemental ledgering data to identify a plurality of supplemental identifiers within the supplemental ledgering data may include deconstructing the supplemental ledgering data to update a distributed ledgering database.

A query may be received concerning a user-defined identifier. Whether the user-defined identifier is included within the plurality of unique identifiers may be determined. If included within the plurality of unique identifiers, one or more objects related to the user-defined identifier may be identified. The user-defined identifier may concern a user-defined entity. Identifying one or more objects related to the user-defined identifier may include identifying one or more entities related to the user-defined identifier, thus defining one or more related entities. Identifying one or more objects related to the user-defined identifier may include identifying one or more transactions related to user-defined specific identifier, thus identifying one or more related transactions. Obtaining distributed ledgering data that defines a plurality of transactions may include obtaining distributed ledgering data that defines a plurality of transactions from a plurality of distributed ledgers. The distributed ledgering data may concern a plurality of cryptocurrencies. Distributed ledgering data concerning a first cryptocurrency may be monitored. Distributed ledgering data concerning at least a second cryptocurrency may be monitored. One or more transactions concerning the first cryptocurrency may be associated with one or more transactions concerning the at least a second cryptocurrency, thus enabling the mapping of potential relationships across multiple blockchain networks. The plurality of unique identifiers may be compared to a list of known bad actors to identify one or more suspect transactions within the plurality of transactions. The transfer data may be compared to a list of known suspect transfer patterns to identify one or more suspect transactions within the plurality of transactions. The transfer data may include temporal transfer data. Comparing the transfer data to a list of known suspect transfer patterns to identify one or more suspect transactions within the plurality of transactions may include comparing the temporal transfer data to a list of known suspect temporal transfer patterns to identify one or more suspect transactions within the plurality of transactions. The distributed ledgering data may be supplemented with third-party content that associates at least a portion of the plurality of unique identifiers with one or more known entities. Associating two or more unique identifiers included within the plurality of unique identifiers with discrete transactions included within the plurality of transactions to generate transfer data may include associating two or more unique identifiers included within the plurality of unique identifiers and any associated known entities with discrete transactions included within the plurality of transactions to generate transfer data.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a data extraction process according to an embodiment of the present disclosure;

FIG. 2 is a diagrammatic view of a data extraction platform including the data extraction process of FIG. 1 according to an embodiment of the present disclosure; and

FIG. 3 is a flowchart of an implementation of the data extraction process of FIG. 1 according to an embodiment of the present disclosure.

Like reference symbols in the various drawings indicate like elements.

### DETAILED DESCRIPTION OF THE PREFERRED EMBODIMENTS

System Overview

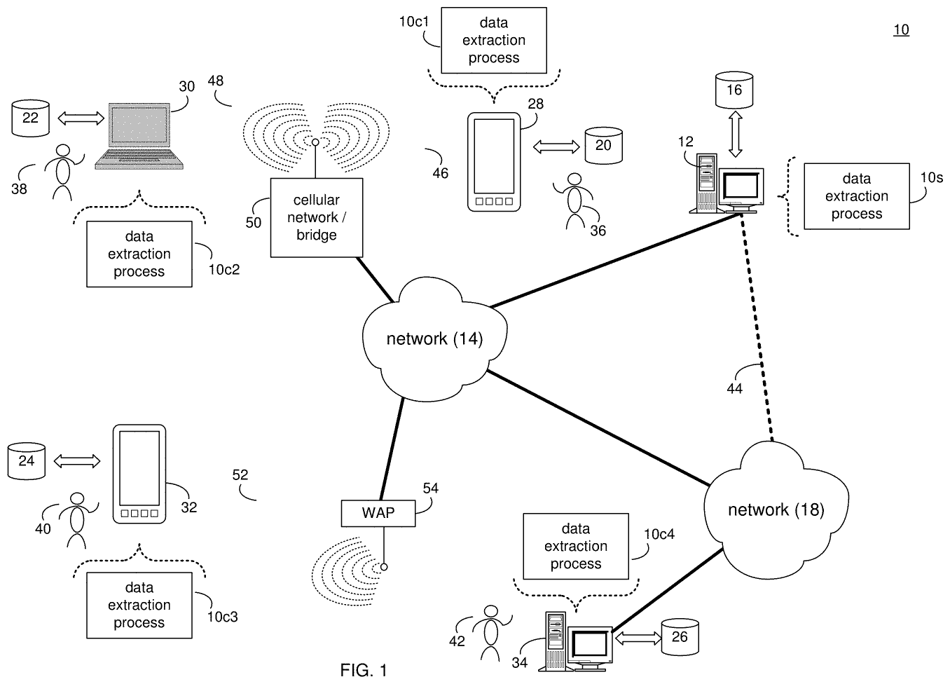

Referring to FIG. 1, there is shown data extraction process 10. Data extraction process 10 may be implemented as a server-side process, a client-side process, or a hybrid server-side/client-side process. For example, data extraction process 10 may be implemented as a purely server-side process via data extraction process 10s. Alternatively, data extraction process 10 may be implemented as a purely client-side process via one or more of data extraction process 10cl, data extraction process 10c2, data extraction process 10c3, and data extraction process 10c4. Alternatively still, data extraction process 10 may be implemented as a hybrid server-side/client-side process via data extraction process 10s in combination with one or more of data extraction process 10cl, data extraction process 10c2, data extraction process 10c3, and data extraction process 10c4. Accordingly, data extraction process 10 as used in this disclosure may include any combination of data extraction process 10s, data extraction process 10cl, data extraction process 10c2, data extraction process, and data extraction process 10c4.

Data extraction process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a cloud-based computing network.

The instruction sets and subroutines of data extraction process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of data extraction processes 10cl, 10c2, 10c3, 10c4 may include but are not limited to a client application, a web browser, a game console user interface, or a specialized application (e.g., an application running on e.g., the Android™ platform or the iOS™ platform). The instruction sets and subroutines of data extraction processes 10cl, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage device 16 may include but are not limited to: a hard disk drive; a RAID device; a random access memory (RAM); a read-only memory (ROM); and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access data extraction process 10 directly through network 14 or through secondary network 18. Further, data extraction process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Data Extraction Process

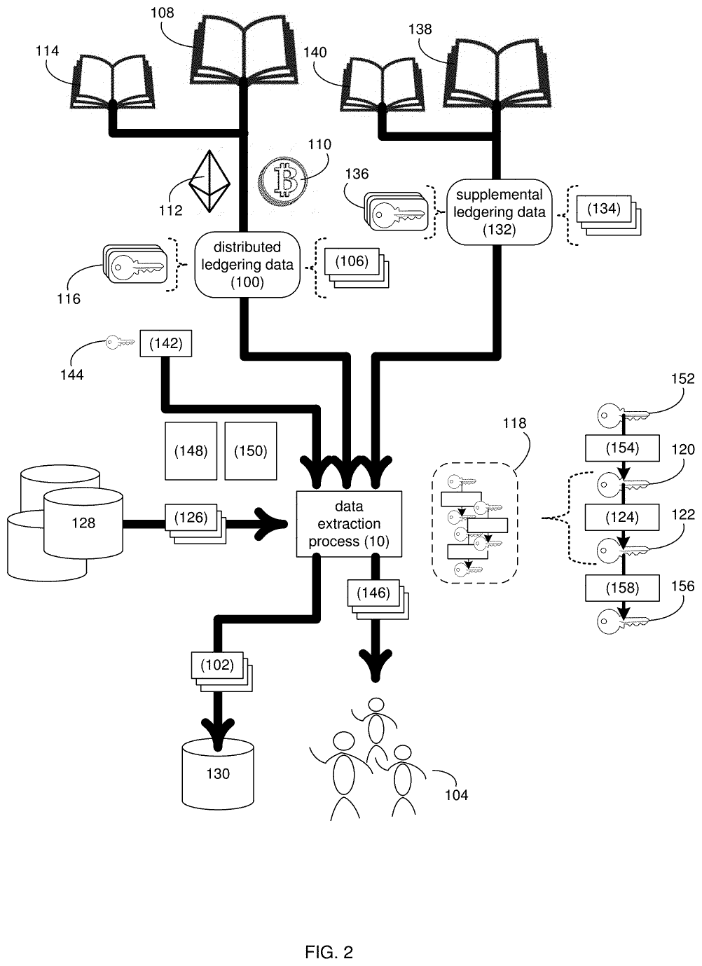

Referring also to FIG. 2 and as will be discussed below in greater detail, distributed ledgering data (e.g., distributed ledgering data 100) may be processed and supplemented by data extraction process 10 so that transfer data 102 may be provided to users (e.g., users 104) in a fashion that is easily comprehendible and digestible.

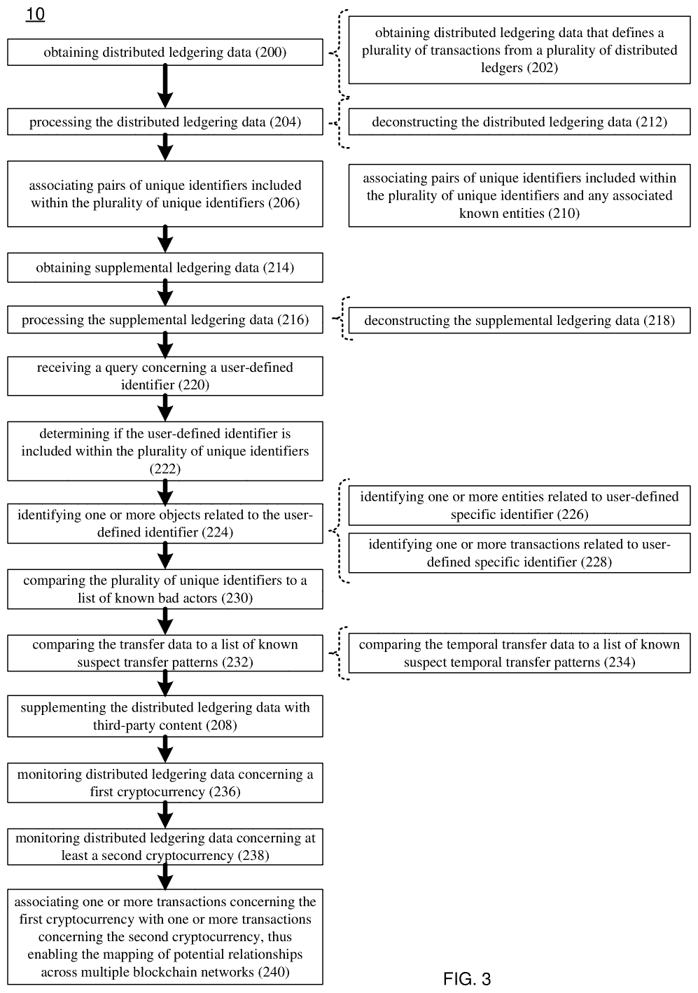

Referring also to FIG. 3, data extraction process 10 may obtain 200 distributed ledgering data 100 that defines a plurality of transactions (e.g., transactions 106). Distributed ledgering data 100 may be obtained from a distributed ledger (e.g., distributed ledger 108).

As is known in the art, distributed ledger 108 (also called a shared ledger or distributed ledger technology or DLT) is a consensus of replicated, shared, and synchronized digital data that is geographically spread across multiple sites, countries, or institutions. There is no central administrator or centralized data storage of distributed ledger 108. As is known in the art, a distributed ledger (e.g., distributed ledger 108) may be utilized with a cryptocurrency, wherein a cryptocurrency is a digital asset designed to work as a medium of exchange that uses strong cryptography to secure financial transactions, control the creation of additional units of the cryptocurrency, and verify the transfer of assets. Cryptocurrencies use decentralized control (as opposed to centralized digital currencies and central banking systems), wherein decentralized control of each cryptocurrency may be achieved through distributed ledger technology (e.g., distributed ledger 108), An example of such distributed ledger technology (e.g., distributed ledger 108) may include but is not limited to a blockchain that may serve as a public financial transaction database. Bitcoin is generally considered to be the first decentralized cryptocurrency, wherein many alternative cryptocurrencies (e.g., Ethereum) have been developed since the release of Bitcoin.

As is known in the art, a blockchain distributed ledger may be a continuously growing list of records (e.g., called blocks) that are linked and secured using cryptography. For example, each block within a blockchain distributed ledger may contain a hash pointer as a link to a previous block. Accordingly, blockchain distributed ledgers may be inherently resistant to modification of the data, as each block in the blockchain distributed ledger may be linked (via a hash function) to the previous block in the blockchain distributed ledger. A block in the blockchain distributed ledger may include transaction data, a hash function that identifies the previous block in the blockchain distributed ledger, and a time/date stamp. Functionally, a blockchain distributed ledger may serve as an open, distributed ledger that may securely record transactions between two parties (e.g., the transfer of cryptocurrency tokens from a first party to a second party) efficiently and in a verifiable and permanent way.

Accordingly, distributed ledgering data 100 may concern at least one cryptocurrency (e.g., cryptocurrency 110), wherein the plurality of transactions (e.g., transactions 106) may concern a plurality of transfers of the at least one cryptocurrency (e.g., cryptocurrency 110). For example, the plurality of transactions (e.g., transactions 106) may concern a plurality of sales concerning a single cryptocurrency (e.g., Party A sold 100 Bitcoin tokens (e.g., cryptocurrency 110) for $800,000 to Party B . . . and Party B sold those 100 Bitcoin tokens (e.g., cryptocurrency 110) for $800,000 to Party C).

Alternatively, distributed ledgering data 100 may concern a plurality of cryptocurrencies (e.g., cryptocurrency 110 and cryptocurrency 112). Accordingly, the plurality of transactions (e.g., transactions 106) may concern a plurality of sales of multiple cryptocurrencies (e.g., Party A sold 100 Bitcoin tokens (e.g., cryptocurrency 110) for $800,000 to Party B . . . Party B sold those 100 Bitcoin tokens (e.g., cryptocurrency 110) for 4,000 Ethereum tokens (e.g., cryptocurrency 112) to Party C . . . and Party C sold those 4,000 Ethereum tokens (e.g., cryptocurrency 112) for $750,000 to Party D.

When obtaining 200 distributed ledgering data 100 that defines a plurality of transactions (e.g., transactions 106), data extraction process 10 may obtain 202 distributed ledgering data 100 that defines a plurality of transactions (e.g., transactions 106) from a plurality of distributed ledgers (e.g., distributed ledger 108 and distributed ledger 114). For example, distributed ledger 108 may memorialize transactions concerning cryptocurrency 110, while distributed ledger 114 may memorialize transactions concerning cryptocurrency 112, wherein transactions 106 may include transactions concerning cryptocurrency 110 (as defined within distributed ledger 108) and transactions concerning cryptocurrency 112 (as defined with distributed ledger 114).

Data extraction process 10 may process 204 distributed ledgering data 100 to identify a plurality of unique identifiers (e.g., plurality of unique identifiers 116) within distributed ledgering data 100. An example of plurality of unique identifiers 116 may include but is not limited to a plurality of unique public encryption keys, a plurality of unique abbreviated portions/variants of public encryption keys, a plurality of unique IP addresses, a plurality of unique MAC addresses, a plurality of unique outputs of hash functions, a plurality of unique alphanumeric strings, and a plurality of unique ASCII strings.

As is known in the art, a distributed ledger (e.g., distributed ledger 108 and/or distributed ledger 114) may utilize cryptography (e.g., in the form of private encryption keys and public encryption keys) to secure (via the use of encryption) and/or authenticate (via the use of digital signatures) entries within distributed ledger 108 and/or distributed ledger 114.

As is known in the art, private key/public key encryption systems utilizes two uniquely related cryptographic keys (i.e., a private key and a public key). The public key is public and therefore made available to everyone via a publicly-accessible key repository or directory. Conversely, the private key is not publicly available and must remain confidential to its respective owner. Because the private key and the public key are mathematically related, whatever is encrypted with a public key may only be decrypted by its corresponding private key [and (conversely) whatever is encrypted with a private key may only be decrypted by its corresponding public key].

For example, if Party A wants to send sensitive data to Party B (and wants to ensure that only Party B can access it), Party A may encrypt the sensitive data with the public key of Party B. Party B may then use their private key to decrypt the encrypted sensitive data sent to them by Party A. Being that only Party B has access to their private key, only Party B may decrypt the encrypted sensitive data. Therefore, even if a third party gains access to the encrypted sensitive data, the third party may not decrypt the encrypted sensitive data without access to the private key of Party B.

Data extraction process 10 may associate 206 two or more unique identifiers (e.g., two or more unique identifiers 118) included within plurality of unique identifiers 116 with discrete transactions included within plurality of transactions 106 to generate transfer data 102.

As discussed above, a transaction may concern the transfer of a portion of cryptocurrency (e.g., Party A sold 100 Bitcoin tokens to Party B). Accordingly, each transaction (e.g., each of plurality of transactions 106) defined within distributed ledgering data 100 may identify a seller (e.g., Party A) and a buyer (e.g., Party B) and the specifics of the transaction (e.g., 100 Bitcoin tokens). Therefore, each of the two or more unique identifiers (e.g., two or more unique identifiers 118) may identify a seller (via e.g., public encryption key 120 of Party A) and a buyer (via e.g., public encryption key 122 of Party B) for a specific transaction (e.g., transaction 124).

Data extraction process 10 may supplement 208 distributed ledgering data 100 with third-party content 126 (e.g., obtained from third party data source 128) that may associate at least a portion of plurality of unique identifiers 116 with one or more known entities (e.g., personal names, business names, etc.). As discussed above, public keys are public and are made available to everyone via a publicly-accessible key repository or directory. Accordingly, an example of third party data source 128 may include such a key repository or directory, thus allowing data extraction process 10 to identify the owner of public encryption key 120 (as Party A) and the owner of public encryption key 122 (as Party B). Other example of third party data source 128 may include but are not limited to mailing address data sources, tax record data sources, financial record data sources, telephone record data sources, legal status data sources, corporate record data sources, criminal record data sources, civil record data sources, etc.).

If such supplementation 208 of distributed ledgering data 100 has occurred, associating 206 two or more unique identifiers (e.g., two or more unique identifiers 118) included within plurality of unique identifiers 116 with discrete transactions included within plurality of transactions 106 to generate transfer data 102 may include associating 210 two or more unique identifiers (e.g., two or more unique identifiers 118) included within the plurality of unique identifiers 116 and any associated known entities with discrete transactions included within the plurality of transactions 106 to generate transfer data 102. Accordingly, in addition to associating 210 public encryption key 120 and public encryption key 122 with transaction 124, the e.g., identity, address, tax records and criminal records of the owner of public encryption key 120 (namely Party A) and encryption key 122 (namely Party B) may also be associated 210.

When data extraction process 10 processes 204 distributed ledgering data 100 to identify a plurality of unique identifiers (e.g., plurality of unique identifiers 116) within distributed ledgering data 100, data extraction process 10 may deconstruct 212 distributed ledgering data 100 to populate distributed ledgering database 130. Distributed ledgering database 130 may be any type of database, examples of which may include but are not limited to an SQL database, an RDBMS database, a relational database, a NoSQL database and non-relational database. Accordingly and as will be discussed below, users (e.g., users 104) of data extraction process 10 may query distributed ledgering database 130 to obtain information about one or more of transactions 106.

To ensure that transfer data 102 (and, therefore, distributed ledgering database 130) remains current & up-to-date, data extraction process 10 may obtain 214 supplemental ledgering data 132 that defines a plurality of supplemental transactions (e.g., transactions 134). Data extraction process 10 may process 216 supplemental ledgering data 132 to identify a plurality of supplemental identifiers (e.g., plurality of supplemental identifiers 136) within supplemental ledgering data 132. An example of plurality of supplemental identifiers (e.g., plurality of supplemental identifiers 136) may include a plurality of unique public encryption keys).

When obtaining 214 supplemental ledgering data 132 that defines a plurality of supplemental transactions (e.g., transactions 134), data extraction process 10 may obtain supplemental ledgering data 132 that defines a plurality of supplemental transactions (e.g., transactions 134) from a plurality of distributed ledgers (e.g., distributed ledger 138 and distributed ledger 140).

When processing 216 supplemental ledgering data 132 to identify a plurality of supplemental identifiers (e.g., plurality of supplemental identifiers 136) within supplemental ledgering data 132, data extraction process 10 may deconstruct 218 supplemental ledgering data 132 to update distributed ledgering database 130.

Searching of Transfer Data

As discussed above, users (e.g., user 104) of data extraction process 10 may query distributed ledgering database 130 to obtain information about one or more of transactions 106 defined within distributed ledgering database 130. Accordingly, data extraction process 10 may receive 220 a query (e.g., query 142) concerning a user-defined identifier (e.g., user-defined identifier 144). An example of user-defined identifier 144 may include but is not limited to a user-defined entity (e.g., a personal name, a corporate name, an exchange name, a public encryption key, a volume of transactions; the frequency of transactions; the number of hops; the number of related addresses; a value of transactions; a value stored in address over time; a distance between related addresses (hops linked by transactions); a shortest transaction path between linked addresses; all transaction paths between linked addresses, etc.).

Assume for this example that user-defined identifier 144 is “Party A”. Upon receiving 220 query 142, data extraction process 10 may determine 222 if the user-defined identifier (e.g., user-defined identifier 144, namely “Party A) is included within plurality of unique identifiers 116 (and plurality of supplemental identifiers 136 if supplemental ledgering data 132 was obtained 214).

If the user-defined identifier (e.g., user-defined identifier 144, namely “Party A) is included within plurality of unique identifiers 116 (or plurality of supplemental identifiers 136 if supplemental ledgering data 132 was obtained 214), data extraction process 10 may identify 224 one or more objects (e.g., objects 146) related to the user-defined identifier (e.g., user-defined identifier 144, namely “Party A).

When identifying 224 one or more objects (e.g., objects 146) related to the user-defined identifier (e.g., user-defined identifier 144, namely “Party A), data extraction process 10 may identify 226 one or more entities (e.g., one or more parties) related to the user-defined identifier (e.g., user-defined identifier 144, namely “Party A), thus defining one or more related entities. Additionally and when identifying 224 or more objects (e.g., objects 146) related to the user-defined identifier (e.g., user-defined identifier 144, namely “Party A), data extraction process 10 may identify 228 one or more transactions (e.g., one or more sales) related to user-defined specific identifier (e.g., user-defined identifier 144, namely “Party A), thus identifying one or more related transactions.

As discussed above and with respect to transaction 124, Party A transferred 100 Bitcoin tokens to Party B. Accordingly and when identifying 224 one or more objects (e.g., objects 146) related to the user-defined identifier (e.g., user-defined identifier 144, namely “Party A”), data extraction process 10:
may identify 226 one or more entities (e.g., Party B) related to “Party A”, as Party B made the Bitcoin purchase from Party A; and
may identify 228 one or more transactions (e.g., the transfer of 100 Bitcoin tokens) related to “Party A”, as Party A sold 100 Bitcoin tokens to Party B.

In addition to reactively responding to the requests (e.g., queries) of users, data extraction process 10 may be configured to be proactive in the analysis of transfer data 102 included within distributed ledgering database 130.

For example, data extraction process 10 may compare 230 plurality of unique identifiers 116 (and plurality of supplemental identifiers 136 if supplemental ledgering data 132 was obtained 214) to a list of known bad actors (e.g., bad actors list 148) to identify one or more suspect transactions within plurality of transactions 106 (and plurality of transactions 134 if supplemental ledgering data 132 was obtained 214). For example, bad actors list 148 may define e.g., a plurality of known money launderers, criminals, drug dealers, criminal enterprises, etc.), wherein the involvement of one of these bad actors may render a specific transactions suspicious.

Further, data extraction process 10 may compare 232 transfer data 102 to a list of known suspect transfer patterns (e.g., bad pattern list 150) to identify one or more suspect transactions within plurality of transactions 106 (and plurality of transactions 134 if supplemental ledgering data 132 was obtained 214). For example, bad pattern list 150 may identify a pattern of tumbling cryptocurrency through a plurality of exchanges to increase the difficulty of tracking the currency flow as a suspicious pattern, wherein a transaction that follows such a pattern may render the transaction suspicious,

Transfer data 102 may include temporal transfer data, wherein a time component may be included so that the period for which cryptocurrency remains in a certain exchange or with a certain party is known. Accordingly and when comparing 232 transfer data 102 to a list of known suspect transfer patterns (e.g., bad pattern list 150) to identify one or more suspect transactions within plurality of transactions 106 (and plurality of transactions 134 if supplemental ledgering data 132 was obtained 214), data extraction process 10 may compare 234 this temporal transfer data to a list of known suspect temporal transfer patterns (e.g., bad pattern list 150) to identify one or more suspect transactions within the plurality of transactions 106 (and plurality of transactions 134 if supplemental ledgering data 132 was obtained 214). For example, bad pattern list 150 may identify a pattern of quickly tumbling cryptocurrency through a plurality of exchanges at a very high rate and for many short durations of time to increase the difficulty of tracking the currency flow as a suspicious pattern, wherein a transaction that follows such a pattern may render the transaction suspicious.

As discussed above, users (e.g., user 104) of data extraction process 10 may query distributed ledgering database 130 to obtain information about one or more of transactions 106 defined within distributed ledgering database 130. Accordingly, data extraction process 10 may receive 220 a query (e.g., query 142) concerning user-defined identifier 144 (e.g., a personal name, a corporate name, an exchange name, a public encryption key, etc.). If user-defined identifier 144 (e.g., “Party A) is included within plurality of unique identifiers 116 (or plurality of supplemental identifiers 136 if supplemental ledgering data 132 was obtained 214), data extraction process 10 may identify 224 one or more objects (e.g., objects 146) related to the user-defined identifier (e.g., user-defined identifier 144, namely “Party A). When identifying 224 one or more objects (e.g., objects 146) related to the user-defined identifier (e.g., user-defined identifier 144, namely “Party A), data extraction process 10 may identify 224 one or more objects (e.g., objects 146) related to the user-defined identifier (e.g., user-defined identifier 144 to multiple levels of separation.

As discussed above and with respect to transaction 124, Party A transferred 100 Bitcoin tokens to Party B. Accordingly and when identifying 224 one or more objects (e.g., objects 146) related to the user-defined identifier (e.g., user-defined identifier 144, namely “Party A”), data extraction process 10:
may identify 226 one or more entities (e.g., identifier 122 i.e., Party B) related to “Party A”, as Party B made the Bitcoin purchase from Party A; and
may identify 228 one or more transactions (e.g., transaction 124 i.e., the transfer of 100 Bitcoin tokens) related to “Party A”, as Party A transferred the 100 Bitcoin tokens to Party B.

Additionally and when identifying 224 one or more objects (e.g., objects 146) related to the user-defined identifier (e.g., user-defined identifier 144, namely “Party A”), data extraction process 10:
may identify 226 one or more entities (e.g., identifier 152 i.e., Party C) related to “Party A”, as Party C transferred the 100 Bitcoin tokens to Party A;
may identify 228 one or more transactions (e.g., transaction 154 i.e., the transfer of the 100 Bitcoin tokens) related to “Party A”, as Party C transferred the 100 Bitcoin tokens to Party A;
may identify 226 one or more entities (e.g., identifier 156 i.e., Party D) related to “Party A”, as Party D made the 100 Bitcoin token purchase from Party B; and
may identify 228 one or more transactions (e.g., transaction 158 i.e., the transfer of the 100 Bitcoin tokens) related to “Party A”, as Party B transferred 100 Bitcoin tokens to Party D.

Accordingly, data extraction process 10 may allow a user (e.g., user 104) to monitor/determine e.g., the flow of a cryptocurrency (in a forward direction or backward direction) through a series of transactions/transactional network.

Black Box Analysis

As discussed above, when obtaining 200 distributed ledgering data 100 that defines a plurality of transactions (e.g., transactions 106), data extraction process 10 may obtain 202 distributed ledgering data 100 that defines a plurality of transactions (e.g., transactions 106) from a plurality of distributed ledgers (e.g., distributed ledger 108 and distributed ledger 114). For example, distributed ledger 108 may memorialize transactions concerning cryptocurrency 110, while distributed ledger 114 may memorialize transactions concerning cryptocurrency 112, wherein transactions 106 may include transactions concerning cryptocurrency 110 (as defined within distributed ledger 108) and transactions concerning cryptocurrency 112 (as defined with distributed ledger 114).

As is known in the art, an exchange (e.g., ShapeShift) may exchange a first cryptocurrency (e.g., cryptocurrency 110) for a second cryptocurrency (e.g., cryptocurrency 112). Unfortunately and during an exchange process in which e.g., a quantity of cryptocurrency 110 (e.g., a quantity of Bitcoin tokens) is exchanged for a quantity of cryptocurrency 112 (e.g., a quantity of Ethereum tokens), as these two cryptocurrencies utilize two different distributed ledgers (e.g., distributed ledger 108 and distributed ledger 114, respectively), monitoring the flow of the cryptocurrency through a transactional network may prove difficult.

Accordingly, data extraction process 10 may be configured to monitor 236 distributed ledgering data (e.g., a first portion of distributed ledgering data 100) concerning a first cryptocurrency (e.g., cryptocurrency 110) and monitor 238 distributed ledgering data (e.g., a second portion of distributed ledgering data 100) concerning at least a second cryptocurrency (e.g., cryptocurrency 112). Data extraction process 10 may then associate 240 one or more transactions concerning the first cryptocurrency (e.g., cryptocurrency 110) with one or more transactions concerning the second cryptocurrency (e.g., cryptocurrency 112), thus enabling mapping across multiple cryptocurrencies.

As discussed above, distributed ledgering data 100 may concern a plurality of cryptocurrencies (e.g., cryptocurrency 110 and cryptocurrency 112). Accordingly, the plurality of transactions (e.g., transactions 106) may concern a plurality of transfers of multiple cryptocurrencies (e.g., Party A transferred 100 Bitcoin tokens (e.g., cryptocurrency 110) for $800,000 to Party B . . . Party B transferred those 100 Bitcoin tokens (e.g., cryptocurrency 110) for 4,000 Ethereum tokens (e.g., cryptocurrency 112) to Party C . . . and Party C transferred those 4,000 Ethereum tokens (e.g., cryptocurrency 112) for $750,000 to Party D. Such an exchange of Bitcoin tokens for Ethereum tokens may be effectuated through an exchange (e.g., Shapeshift), wherein the Bitcoin transaction may be recorded on distributed ledger 108 while the Ethereum transaction may be recorded on distributed ledger 114.

Since data extraction process 10 may be configured to monitor 236 distributed ledgering data (e.g., a first portion of distributed ledgering data 100) concerning a first cryptocurrency (e.g., cryptocurrency 110) and monitor 238 distributed ledgering data (e.g., a second portion of distributed ledgering data 100) concerning at least a second cryptocurrency (e.g., cryptocurrency 112), data extraction process 10 may associate 240 the inbound transfer of 100 Bitcoin tokens (e.g., cryptocurrency 110) appearing on distributed ledger 108 with the outbound transfer of 4,000 Ethereum tokens (e.g., cryptocurrency 112) appearing on distributed ledger 114, thus enabling the mapping of potential relationships across multiple blockchain networks.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing system, comprising:
obtaining distributed ledgering data that defines a plurality of transactions;
processing the distributed ledgering data to identify a plurality of unique identifiers within the distributed ledgering data; and
associating two or more unique identifiers included within the plurality of unique identifiers with discrete transactions included within the plurality of transactions to generate transfer data.

2. The computer-implemented method of claim 1 wherein the distributed ledgering data concerns at least one cryptocurrency.

3. The computer-implemented method of claim 2 wherein the plurality of transactions concern a plurality of transfers of the at least one cryptocurrency.

4. The computer-implemented method of claim 1 wherein the plurality of unique identifiers includes a plurality of unique public encryption keys.

5. The computer-implemented method of claim 1 wherein processing the distributed ledgering data to identify a plurality of unique identifiers within the distributed ledgering data includes:
deconstructing the distributed ledgering data to populate a distributed ledgering database.

6. The computer-implemented method of claim 1 further comprising:
obtaining supplemental ledgering data that defines a plurality of supplemental transactions; and
processing the supplemental ledgering data to identify a plurality of supplemental identifiers within the supplemental ledgering data.

7. The computer-implemented method of claim 6 wherein processing the supplemental ledgering data to identify a plurality of supplemental identifiers within the supplemental ledgering data includes:
deconstructing the supplemental ledgering data to update a distributed ledgering database.

8. The computer-implemented method of claim 1 further comprising:
receiving a query concerning a user-defined identifier;
determining if the user-defined identifier is included within the plurality of unique identifiers; and
if included within the plurality of unique identifiers, identifying one or more objects related to the user-defined identifier.

9. The computer-implemented method of claim 8 wherein the user-defined identifier concerns a user-defined entity.

10. The computer-implemented method of claim 8 wherein identifying one or more objects related to the user-defined identifier includes:
identifying one or more entities related to the user-defined identifier, thus defining one or more related entities.

11. The computer-implemented method of claim 8 wherein identifying one or more objects related to the user-defined identifier includes:
identifying one or more transactions related to user-defined specific identifier, thus identifying one or more related transactions.

12. The computer-implemented method of claim 1 wherein obtaining distributed ledgering data that defines a plurality of transactions includes:
obtaining distributed ledgering data that defines a plurality of transactions from a plurality of distributed ledgers.

13. The computer-implemented method of claim 12 wherein the distributed ledgering data concerns a plurality of cryptocurrencies.

14. The computer-implemented method of claim 13 further comprising:
monitoring distributed ledgering data concerning a first cryptocurrency;
monitoring distributed ledgering data concerning at least a second cryptocurrency; and
associating one or more transactions concerning the first cryptocurrency with one or more transactions concerning the at least a second cryptocurrency, thus enabling the mapping of potential relationships across multiple blockchain networks.

15. The computer-implemented method of claim 1 further comprising one or more of:
comparing the plurality of unique identifiers to a list of known bad actors to identify one or more suspect transactions within the plurality of transactions; and
comparing the transfer data to a list of known suspect transfer patterns to identify one or more suspect transactions within the plurality of transactions.

16. The computer-implemented method of claim 15 wherein the transfer data includes temporal transfer data.

17. The computer-implemented method of claim 16 wherein comparing the transfer data to a list of known suspect transfer patterns to identify one or more suspect transactions within the plurality of transactions includes:
comparing the temporal transfer data to a list of known suspect temporal transfer patterns to identify one or more suspect transactions within the plurality of transactions.

18. The computer-implemented method of claim 1 further comprising:
supplementing the distributed ledgering data with third-party content that associates at least a portion of the plurality of unique identifiers with one or more known entities.

19. The computer-implemented method of claim 18 wherein associating two or more unique identifiers included within the plurality of unique identifiers with discrete transactions included within the plurality of transactions to generate transfer data includes:
associating two or more unique identifiers included within the plurality of unique identifiers and any associated known entities with discrete transactions included within the plurality of transactions to generate transfer data.

20. A computer program product residing on a computer readable medium having a plurality of instructions stored thereon which, when executed by a processor, cause the processor to perform operations comprising:
obtaining distributed ledgering data that defines a plurality of transactions;
processing the distributed ledgering data to identify a plurality of unique identifiers within the distributed ledgering data; and
associating two or more unique identifiers included within the plurality of unique identifiers with discrete transactions included within the plurality of transactions to generate transfer data.

21. The computer program product of claim 20 wherein the distributed ledgering data concerns at least one cryptocurrency.

22. The computer program product of claim 21 wherein the plurality of transactions concern a plurality of transfers of the at least one cryptocurrency.

23. The computer program product of claim 20 wherein the plurality of unique identifiers includes a plurality of unique public encryption keys.

24. The computer program product of claim 20 wherein processing the distributed ledgering data to identify a plurality of unique identifiers within the distributed ledgering data includes:
deconstructing the distributed ledgering data to populate a distributed ledgering database.

25. The computer program product of claim 20 further comprising:
obtaining supplemental ledgering data that defines a plurality of supplemental transactions; and
processing the supplemental ledgering data to identify a plurality of supplemental identifiers within the supplemental ledgering data.

26. The computer program product of claim 25 wherein processing the supplemental ledgering data to identify a plurality of supplemental identifiers within the supplemental ledgering data includes:
deconstructing the supplemental ledgering data to update a distributed ledgering database.

27. The computer program product of claim 20 further comprising:
receiving a query concerning a user-defined identifier;
determining if the user-defined identifier is included within the plurality of unique identifiers; and
if included within the plurality of unique identifiers, identifying one or more objects related to the user-defined identifier.

28. The computer program product of claim 27 wherein the user-defined identifier concerns a user-defined entity.

29. The computer program product of claim 27 wherein identifying one or more objects related to the user-defined identifier includes:
identifying one or more entities related to the user-defined identifier, thus defining one or more related entities.

30. The computer program product of claim 27 wherein identifying one or more objects related to the user-defined identifier includes:
identifying one or more transactions related to user-defined specific identifier, thus identifying one or more related transactions.

31. The computer program product of claim 20 wherein obtaining distributed ledgering data that defines a plurality of transactions includes:
obtaining distributed ledgering data that defines a plurality of transactions from a plurality of distributed ledgers.

32. The computer program product of claim 31 wherein the distributed ledgering data concerns a plurality of cryptocurrencies.

33. The computer program product of claim 32 further comprising:
monitoring distributed ledgering data concerning a first cryptocurrency;
monitoring distributed ledgering data concerning at least a second cryptocurrency; and
associating one or more transactions concerning the first cryptocurrency with one or more transactions concerning the at least a second cryptocurrency, thus enabling the mapping of potential relationships across multiple blockchain networks.

34. The computer program product of claim 20 further comprising one or more of:
comparing the plurality of unique identifiers to a list of known bad actors to identify one or more suspect transactions within the plurality of transactions; and
comparing the transfer data to a list of known suspect transfer patterns to identify one or more suspect transactions within the plurality of transactions.

35. The computer program product of claim 34 wherein the transfer data includes temporal transfer data.

36. The computer program product of claim 35 wherein comparing the transfer data to a list of known suspect transfer patterns to identify one or more suspect transactions within the plurality of transactions includes:
comparing the temporal transfer data to a list of known suspect temporal transfer patterns to identify one or more suspect transactions within the plurality of transactions.

37. The computer program product of claim 20 further comprising:
supplementing the distributed ledgering data with third-party content that associates at least a portion of the plurality of unique identifiers with one or more known entities.

38. The computer program product of claim 27 wherein associating two or more unique identifiers included within the plurality of unique identifiers with discrete transactions included within the plurality of transactions to generate transfer data includes:
associating two or more unique identifiers included within the plurality of unique identifiers and any associated known entities with discrete transactions included within the plurality of transactions to generate transfer data.

39. A computing system including a processor and memory configured to perform operations comprising:
obtaining distributed ledgering data that defines a plurality of transactions;
processing the distributed ledgering data to identify a plurality of unique identifiers within the distributed ledgering data; and
associating two or more unique identifiers included within the plurality of unique identifiers with discrete transactions included within the plurality of transactions to generate transfer data.

40. The computing system of claim 39 wherein the distributed ledgering data concerns at least one cryptocurrency.

41. The computing system of claim 40 wherein the plurality of transactions concern a plurality of transfers of the at least one cryptocurrency.

42. The computing system of claim 39 wherein the plurality of unique identifiers includes a plurality of unique public encryption keys.

43. The computing system of claim 39 wherein processing the distributed ledgering data to identify a plurality of unique identifiers within the distributed ledgering data includes:
deconstructing the distributed ledgering data to populate a distributed ledgering database.

44. The computing system of claim 39 further comprising:
obtaining supplemental ledgering data that defines a plurality of supplemental transactions; and
processing the supplemental ledgering data to identify a plurality of supplemental identifiers within the supplemental ledgering data.

45. The computing system of claim 44 wherein processing the supplemental ledgering data to identify a plurality of supplemental identifiers within the supplemental ledgering data includes:
deconstructing the supplemental ledgering data to update a distributed ledgering database.

46. The computing system of claim 39 further comprising:
receiving a query concerning a user-defined identifier;
determining if the user-defined identifier is included within the plurality of unique identifiers; and
if included within the plurality of unique identifiers, identifying one or more objects related to the user-defined identifier.

47. The computing system of claim 46 wherein the user-defined identifier concerns a user-defined entity.

48. The computing system of claim 46 wherein identifying one or more objects related to the user-defined identifier includes:
identifying one or more entities related to the user-defined identifier, thus defining one or more related entities.

49. The computing system of claim 46 wherein identifying one or more objects related to the user-defined identifier includes:
identifying one or more transactions related to user-defined specific identifier, thus identifying one or more related transactions.

50. The computing system of claim 39 wherein obtaining distributed ledgering data that defines a plurality of transactions includes:
obtaining distributed ledgering data that defines a plurality of transactions from a plurality of distributed ledgers.

51. The computing system of claim 50 wherein the distributed ledgering data concerns a plurality of cryptocurrencies.

52. The computing system of claim 51 further comprising:
monitoring distributed ledgering data concerning a first cryptocurrency;
monitoring distributed ledgering data concerning at least a second cryptocurrency; and
associating one or more transactions concerning the first cryptocurrency with one or more transactions concerning the at least a second cryptocurrency, thus enabling the mapping of potential relationships across multiple blockchain networks.

53. The computing system of claim 39 further comprising one or more of:
comparing the plurality of unique identifiers to a list of known bad actors to identify one or more suspect transactions within the plurality of transactions; and
comparing the transfer data to a list of known suspect transfer patterns to identify one or more suspect transactions within the plurality of transactions.

54. The computing system of claim 53 wherein the transfer data includes temporal transfer data.

55. The computing system of claim 54 wherein comparing the transfer data to a list of known suspect transfer patterns to identify one or more suspect transactions within the plurality of transactions includes:
comparing the temporal transfer data to a list of known suspect temporal transfer patterns to identify one or more suspect transactions within the plurality of transactions.

56. The computing system of claim 39 further comprising:
supplementing the distributed ledgering data with third-party content that associates at least a portion of the plurality of unique identifiers with one or more known entities.

57. The computing system of claim 56 wherein associating two or more unique identifiers included within the plurality of unique identifiers with discrete transactions included within the plurality of transactions to generate transfer data includes:
associating two or more unique identifiers included within the plurality of unique identifiers and any associated known entities with discrete transactions included within the plurality of transactions to generate transfer data.
